(19) United States
(12) Patent Application Publication
(10) Pub. No.: US 2010/0122461 A1
(43) Pub. Date: May 20, 2010

(54) COMPACT SPRING LOADED FUEL CELL MONOPOLAR STACK

(76) Inventors: Constantinos Minas, Slingerlands, NY (US); Charles C. Carlstrom, JR., Saratoga Springs, NY (US)

Correspondence Address: CESARI AND MCKENNA, LLP, 88 BLACK FALCON AVENUE, BOSTON, MA, 02210, US

(21) Appl. No.: 12/274,521

(22) Filed: Nov. 20, 2008

(51) Int. Cl. B23P 15/26; H01M 2/10; H01M 8/04

(52) U.S. Cl. 29/890.034; 429/12; 429/26

(57) ABSTRACT

A spring assembly for use with a direct oxidation fuel cell system is provided. The spring assembly includes a pair of spring elements, placed over each of the major dimensions of the fuel cell, such that the top and bottom spring elements provide at least a portion of the load to the fuel cell for the required compression. The springs are designed to be fully compressed under the design pressure and are held in the compressed state by two side clamps thus providing a uniform planar pressure distribution across the fuel cell system. The spring elements each include several grooves formed therein extending towards center of the element. The side clamps include fastening members which are fingerlike extensions that fit within the grooves of the spring elements to hold the springs in tight engagement over the fuel cell system, with out bolts, pins or other fasteners.

### CROSS REFERENCE TO RELATED APPLICATIONS

This application is related to commonly owned U.S. patent application of Leach, et al., entitled DIRECT OXIDATION FUEL CELL SYSTEM WITH UNIFORM VAPOR DELIVERY OF FUEL, which is being filed on even date herewith and is identified by Attorney Docket No. 107044-0077, and which is presently incorporated by reference herein in its entirety, and commonly owned U.S. patent application of Carlstrom, et al., entitled HEAT SPREADER FOR USE WITH A DIRECT OXIDATION FUEL CELL, which is being filed on even date herewith and is identified by Attorney Docket No. 107044-0078, and which is presently incorporated by reference herein in its entirety.

### BACKGROUND OF THE INVENTION

1. Field of the Invention

The present invention is related generally to direct oxidation fuel cell systems, and more particularly, to spring loaded compression for such systems.

2. Background Information

Fuel cell power systems that convert an organic fuel such as methanol or ethanol and an oxidant into electricity are generally categorized into two types. In the first type, a fuel reformer is used to convert the organic fuel stream into a fuel stream containing hydrogen gas. The hydrogen gas is fed to the anode of a hydrogen-fueled fuel cell.

The second type is a direct oxidation fuel cell (DOFC) in which the organic fuel is reacted directly at an anode catalyst electrode of a membrane electrode assembly (MEA) of the fuel cell. An example of a direct oxidation fuel cell is the direct methanol fuel cell (DMFC). The half reactions for a DMFC are:

Anode: CH₃OH+H₂O→CO₂+6e⁻+6⁺

Cathode: 6e⁻+6H⁺+³/₂O₂→3H₂O

Many DMFC systems known in the art are liquid-feed systems that circulate a low-molarity methanol/water fuel solution through an anode flow field adjacent to an anode gas diffusion layer (GDL). Carbon dioxide (CO₂ ) that is generated in the anode reaction exits through the anode flow field with the unused fuel solution where it is separated before the unused fuel solution is recirculated through the anode flow field.

Some liquid-feed DMFC systems operate using substantially 100% methanol and employ an active system to manage water in the fuel cell. Water is needed for the anode half reaction (as noted in the above reaction equations). Additionally, the cathode aspect of the membrane must be kept adequately hydrated, but not saturated or flooded. Thus, active water management systems are employed that include techniques for capturing water generated at the cathode and returning it to the anode. This replaces: (i) water lost to the anode reaction, (ii) water leaving the system through the CO₂ vent, or (iii) water crossing over the polymer-electrolyte membrane (PEM) from the anode to the cathode.

Furthermore, it has been found that DOFCs operate best when fuel and oxygen are delivered uniformly to an adequately-hydrated MEA. In a liquid-feed system, water is mixed with the fuel, which provides hydration of the PEM. In addition, fuel is provided in concentration levels adequate to evenly feed the full active area of the membrane. Concentration of the fuel can be managed so that the beginning of the flow path is not over concentrated and the end of the flow path is not under concentrated. In such cases, the energy required to distribute the fuel across the MEA active area comes from a liquid pump. But, these systems also require water delivery and/or recirculation mechanisms such as pumps and conduits for recirculating unused fuel and water back to the anode of the fuel cell.

In the related application incorporated herein, a system is described in which fuel distribution is provided by a unique fuel distribution structure into which a liquid fuel is introduced to a flow channel. As the fuel travels in the flow channel, it vaporizes such that the vapor pressure of the fuel assists in the uniform delivery of the fuel to the anode aspect of the MEA. One illustrative embodiment of the system is a fuel cell system having a monopolar stack configuration. In that configuration, the fuel distribution structure is sandwiched between two membrane electrode assemblies, with the anode aspect of each membrane electrode assembly facing the fuel distribution structure. The fuel distribution structure has a fuel feed port into which fuel is injected laterally onto a flow field plate having flow channels formed in it. As the fuel travels in the flow field channels, it is substantially converted to a vapor by the heat of the fuel cell operation. Advantageously, the resulting vapor pressure works to distribute fuel substantially uniformly across each anode aspect, while substantially preventing uneven “hot spots” of fuel.

In such fuel cell systems, as is the case with many fuel cell systems, the MEA is held under compression by one or more mechanisms, such as with applied precompression that is maintained with a series of pins, bolts and plastic molding. Even with such devices, the MEA can begin to relax over time, exhibiting an undesired property known as its creep characteristic. In a constant strain system, such as a fuel cell assembly where the anode and cathode current collectors are structurally connected together at a fixed distance, creep is defined as a drop in load or pressure with time. As the MEA creeps over time, a part or all of the applied precompression is relaxed, which results in increased contact resistance of the fuel cell. These characteristics reduce the performance of the fuel cell. In addition, leakage of fuel cell working liquid from the anode and cathode can occur at the perimeter of the MEA in such systems.

In a monopolar stack configuration, the typical monopolar stack is held under compression by a series of bolts and a top and bottom compression plate. These fasteners and components required for compression are of substantial volume and weight. In addition, plastic fasteners or molding tends to deform with time. As noted, additionally, the MEA tends to creep over time resulting in increased contact resistance in the multiple layers of the fuel cell stack, thus reducing stack performance.

There remains a need, therefore, for a design which addresses the problem of MEA creep, such as in a monopolar stack configuration. There is a further need for a design which does not require bolts and other components, such as compression plates, which add to the size, bulk and weight of the fuel cell system.

It is thus an object of the invention to provide a fuel cell system, which allows for the MEA to maintain adequate compression without the need for heavy pins, bolts and additional compression plates or plastic frames.

### SUMMARY OF THE INVENTION

The disadvantages of prior techniques are addressed by the present invention which is a spring assembly for use with a monopolar stack direct oxidation fuel cell system. In an illustrative embodiment, a monopolar stack configuration of a fuel cell system includes a pair of flat spring elements, placed over each of the major dimensions of the fuel cell stack, such that the top and bottom spring elements provide at least a portion of the load to the fuel cell for the required compression. The springs are designed to be fully compressed under the design pressure and are held in the compressed state by two side clamps.

More specifically, each spring element is substantially comprised of a generally rectangular single sheet of metal having a plurality of cross beams separated by shaped openings between the beams. The spring elements also include several grooves formed therein extending in from an outer perimeter towards center of the element. Side clamps engage the perimeter of the spring elements with fastening members, which are fingerlike extensions that fit within the grooves of the spring elements to hold the spring elements in compression and in tight engagement over the fuel cell system.

The fuel cell system is formed in a monopolar stack configuration and it includes a pair of membrane electrode assemblies. In addition, the fuel cell system includes a pair of enthalpy exchanger and heat spreader assemblies to manage the heat, temperature and condensation in the system. In an illustrative embodiment, there are two such assemblies, one disposed on either side of the fuel cell system, with each such respective enthalpy exchanger and heat spreader assembly being associated with one of the membrane electrode assemblies. In this embodiment, each enthalpy exchanger and heat spreader assembly includes a cold side element that is disposed adjacent to the cathode aspect of its membrane electrode assembly. This cold side element has a heat spreader plate which diffuses and redirects heat in a desired manner in the fuel cell. Notably, the heat spreader plate is a copper plate that also acts as a compression plate distributing uniformly a substantial amount of compression to the MEA.

Each enthalpy exchanger and heat spreader assembly includes a hot side element that has an inwardly facing side that faces into the fuel cell system. This inwardly facing side has flow channels through which air exiting from the cathode is directed towards the exit of the fuel cell system. The opposite aspect of the hot side element faces outwardly towards the ambient environment.

Advantageously, in accordance with another aspect of the present invention, the outwardly facing side of the hot side element includes ribs that are sized to receive the spring elements. When the fuel cell is assembled, the spring elements are placed adjacent to the outwardly facing side of each hot side element and the spring elements fit within the ribs on the hot side element. The side clamps are then placed on either side of the fuel cell system and the fastening members on the side clamps fit within the grooves of the spring elements such that the spring assembly adds little to the overall height in the Z-direction of the fuel cell system. Moreover, because the copper heat spreader plate distributes uniformly a substantial amount of the compression for the MEA, then a separate compression plate is not needed in the fuel cell system, thus further reducing the size, weight and complexity of the fuel cell system.

### BRIEF DESCRIPTION OF THE DRAWINGS

The invention description below refers to the accompanying drawings, of which:

FIG. 1 is a schematic side section of a monopolar stack fuel cell system and spring assembly in accordance with an illustrative embodiment of the present invention;

FIG. 2 is an isometric illustration of one embodiment of a spring element of the spring assembly of the present invention;

FIG. 3 is an isometric illustration of a side clamp of the spring assembly of the present invention;

FIG. 4 is an isometric side section of a spring assembly of the present invention illustrating a side clamp engaged with a spring element;

FIG. 5 is an isometric side section of a fuel cell system and spring assembly of the present invention in an uncompressed state;

FIG. 6 is an isometric side section of a fuel cell system and spring assembly of the present invention in a compressed state;

FIG. 7 is an isometric illustration of a compressed spring element and side clamp also illustrating the directional deformation along a dimension of the spring element;

FIG. 8 is an exploded view of a monopolar stack configuration of a fuel cell system with which the present invention may be advantageously employed; and

FIG. 9 is an isometric illustration of the monopolar stack fuel cell system and spring assembly in accordance with an illustrative embodiment of the present invention.

### DETAILED DESCRIPTION OF AN ILLUSTRATIVE EMBODIMENT

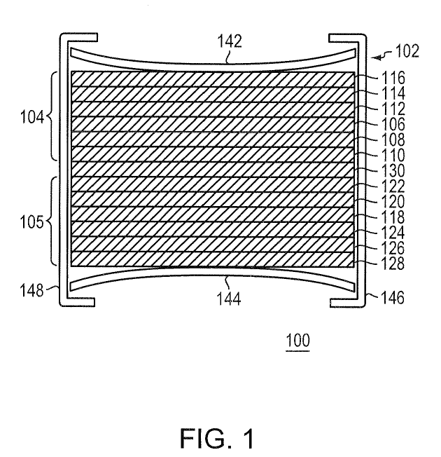

FIG. 1 is a schematic side section of a monopolar stack fuel cell system 100 that includes spring assembly 102 in accordance with an illustrative embodiment of the present invention. The fuel cell system 100 is a monopolar stack configuration that has a pair of fuel cells 104, 105. The fuel cell 104 includes a membrane electrode assembly (MEA) 106 that has, as will be understood by those skilled in the art, a polymer electrolyte membrane, which has on each of its major surfaces, an anode catalyst electrode layer and a cathode catalyst electrode layer (not separately shown in FIG. 1). The anode catalyst electrode layer has an associated microporous layer, such as a methanol diffusion film and an anode gas diffusion layer, collectively designated 108. There is also an anode current collector 110 comprised of a good electrical conductor. Similarly, the cathode catalyst electrode layer has an associated microporous layer and a cathode gas diffusion layer 112.

The second fuel cell 105 has MEA 118, with its anode aspect facing the anode aspect of the first fuel cell 104. Fuel cell 105 has an anode methanol diffusion film and an anode gas diffusion layer, collectively designated 120, and an anode current collector 122 comprised of a good electrical conductor. Similarly, the cathode catalyst electrode layer has an associated microporous layer and a cathode gas diffusion layer 124.

For purposes of clarity of illustration, each component is illustrated as a separate layer in FIG. 1. However, it should be understood that it is within the scope of the invention that embodiments may include a single component that performs the functionality of two or more of the layers illustrated in FIG. 1.

Fuel distribution is provided by a unique fuel distribution structure 130 that is sandwiched between the two fuel cells and which distributes fuel to the anode aspect of each membrane electrode assembly. Illustratively, the fuel distribution structure 130 has a fuel feed port (not shown) into which fuel is injected laterally onto a flow field plate having flow channels formed in it. As the fuel travels in the flow field channels, it is substantially converted to a vapor by the heat of the fuel cell operation. Advantageously, the resulting vapor pressure works to distribute fuel substantially uniformly across each anode aspect, while substantially preventing uneven “hot spots” of fuel. Further details regarding the construction and operation of the fuel distribution structure are provided in the above incorporated U.S. patent application Ser. No. [Attorney Docket No. 107044-0077].

Each fuel cell 104, 105 includes an enthalpy exchanger and heat exchanger assembly, which are referred to herein simply as the “enthalpy exchangers.” The enthalpy exchanger for the fuel cell 104 includes a first element 114 that is a dry, cold side. A second element 116 of the enthalpy exchanger is a hot, inlet side, which includes a flow field into which moist warm exiting air travels. The air is delivered under pressure by, for example, an air pump. An enthalpy exchange membrane (not shown) acts to transfer exhaust heat and water vapor generated at the cathode to the air entering the cold side 114 of the enthalpy exchanger to thereby maintain the humidity of the MEA 106. Similarly, the second fuel cell 105 includes an enthalpy exchanger that has a cold side element 126 and a hot side element 128.

More specifically, in operation, the enthalpy exchangers receive an incoming oxidant reactant air stream via an inlet manifold. The incoming air stream is directed into the cold side element 114, 126. In a counter flowing manner, an outgoing exhaust travels in channels on the hot side elements 116, 128 leading from the cathode of the fuel cells. The outlet hot side elements 116, 128 and the inlet cold side elements 114, 126 are separated by enthalpy exchange membranes (not shown), which may be water permeable membranes that, when saturated, resist the flow of gas there through, but act to collect moisture from the exhaust and allow that moisture to be picked up by the passing inlet stream, thus humidifying the stream before it enters the cathode. This resists membrane dry out. The effects are further enhanced by a water pushback technique in which water is directed from cathode to anode for the anodic reaction of the fuel cell.

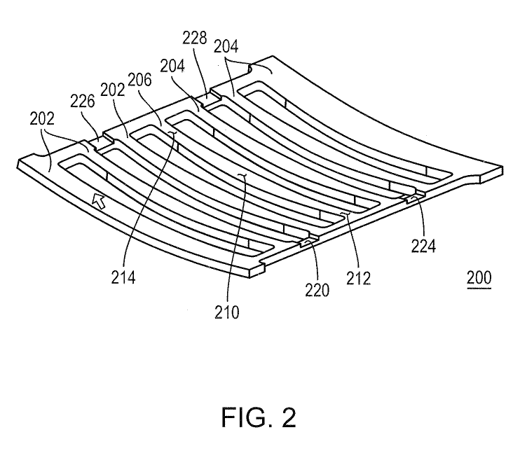

The spring assembly 102 of the present invention acts to hold the components of fuel cell system 100 stably together providing compression required for optimal fuel cell operation. More specifically, the spring assembly 102 includes a top spring element 142 and bottom spring element 144. The spring elements 142 and 144 are held together by side clamps 146 and 148, as described in further detail with reference to FIGS. 2-8.

FIG. 2 is an isometric illustration of one embodiment of a spring element 200 of the spring assembly of the present invention. The spring element 200 is of a generally rectangular shape and its area is sized to fit over the outer aspect of the fuel cell system 100. As illustrated in FIG. 2, the spring element 200 is curved when it is in an uncompressed state, and has a thickness that is designed in order to provide the required compression when the spring is deformed and a free height that is designed in order to provide a flat spring when the spring is deformed. The spring free height is substantially higher than the MEA compression, in order to be able to counteract the MEA creep without significant compression reduction of the stack. The spring element 200 has a plurality of beams such as the beams 202, 204 and 206. Each beam, such as the beam 206, is shaped such that it is wider in a middle portion 210, and more narrow at each end portion 212, 214. This geometry provides the spring element with the characteristic that it is subjected to a substantially constant stress when deformed. Constant stress enables maximum use of the spring material, which provides for a lighter weight component.

Preferably, the spring element 200 is substantially comprised of a high strength stainless steel, but the spring element 200 may also be comprised of carbon steel, titanium, or other metal alloys. The spring element is made out of metal to maintain a substantially zero creep rate at operating temperatures. Plastic, on the other hand, does creep at such operating temperatures, which results in reduced stack compression. Furthermore, as the MEA in each fuel cell creeps over time, the spring elements deflect slightly to allow for some movement, while still stabilizing and maintaining the stack under compression required for continued optimal operation.

The spring element 200 has a number of grooves 220, 224, 226 and 228 formed therein extending from an outer perimeter in towards the center of the element. These grooves are adapted to receive fastening members on an associated side clamp.

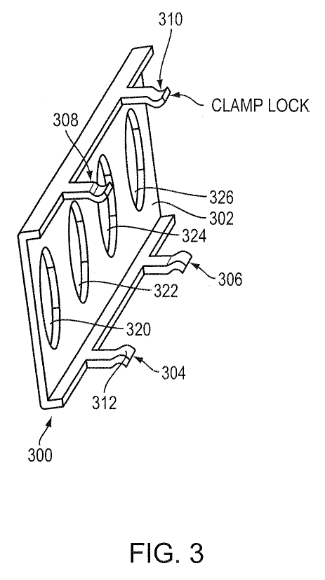

FIG. 3 is an isometric illustration of a side clamp 300 of the spring assembly of the present invention. The side clamp 300 has a generally rectangular body portion 302 that is sized to fit over the smaller dimension of the fuel cell system. A set of fastening members 304, 306 are disposed perpendicularly to one side of the body 302, and a second set of fastening members 308, 310 are disposed perpendicularly to the opposite side of the body. These fastening members, such as member 304 have an end portion 312 that has a curved shape that is formed to be received within a recess in the corresponding groove on the spring element. The openings 320, 322, 324 and 326 allow access to the fuel cell system for porting such as for incoming reactants, as well as for exiting exhaust. Additionally, electronics and wiring can be routed through the openings 320-326 as needed. Moreover, the openings allow the component to be comprised of less material thereby giving rise to a lighter weight part. The side clamp can be made of carbon steel, with a high yield stress that allows the component to operate in the elastic domain. Other similar high strength metals can also be used.

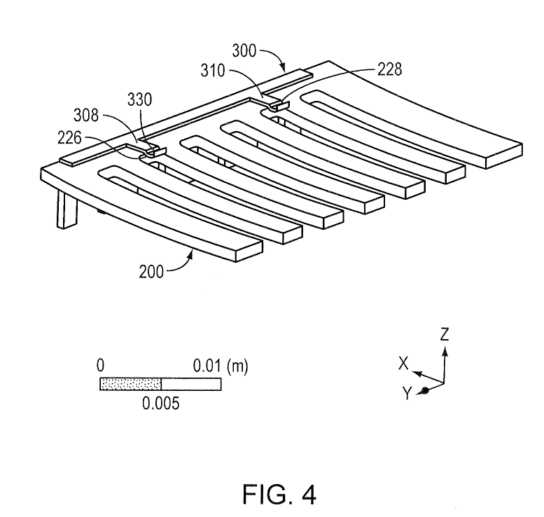

FIG. 4 is an isometric side section of a spring assembly of the present invention illustrating the side clamp 300 engaged with the spring element 200. The fastening member 308 is received within a groove 226 in the spring element 200. A curved portion 330 is received within a recess in the groove 226 of the spring element to provide a locking engagement to secure the side clamp to the spring element without the need for bolts and other fasteners. Similarly, the fastening member 310, for example, fits within the groove 228 in the spring element 200. The fastening members are received substantially into the grooves so that these fasteners do not add to the overall height in the Z direction as shown in FIG. 4.

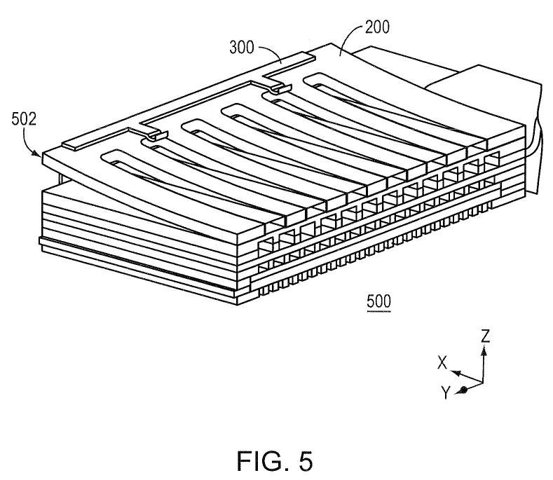

FIG. 5 is an isometric side section of an illustrative embodiment of a fuel cell system 500 and spring assembly 502 in accordance with the present invention. The fuel cell system 500 will be held together by the spring assembly 502 that includes spring element 200 and side clamp 300 as described above. FIG. 5 illustrates the spring assembly in an uncompressed state.

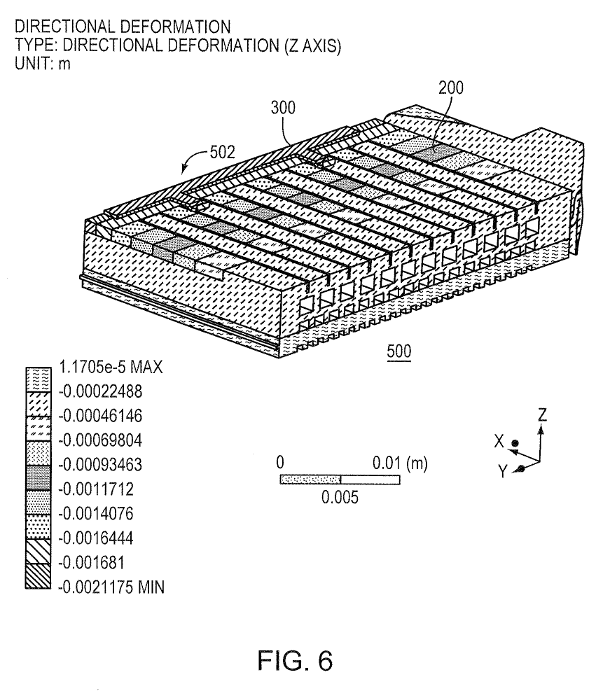

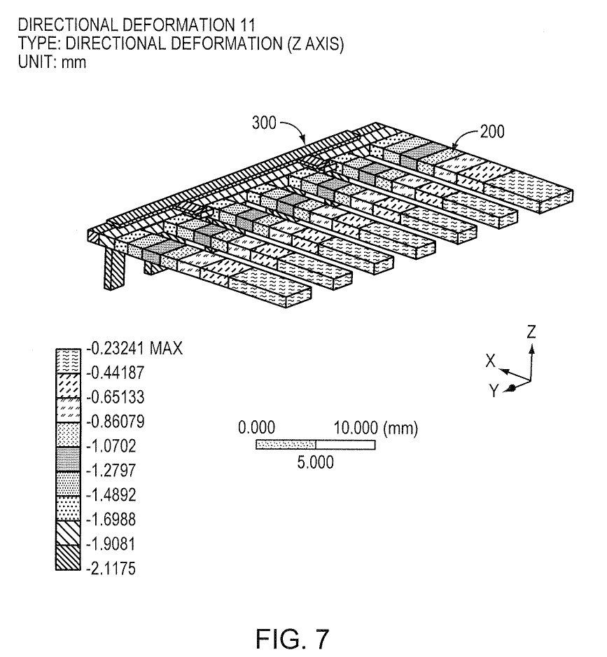

FIG. 6 is an isometric side section of a fuel cell system and spring assembly of the present invention in which the fuel cell system 500 has a spring assembly 502 in a compressed state. The figure also illustrates the directional deformation of the spring element 200. As illustrated by the double hatched shading towards the center of the figure, the center of the spring element exhibits less deformation than the deformation at the edge that is clamped by the side clamp. This is due to the fact that the edge was curved initially as can also be appreciated from FIG. 7, which illustrates the spring and side clamp separately from the fuel cell system. The flat, leaf spring design allows the spring element to apply stress to the fuel cell when it is flat. This, in turn, allows the spring to provide such compression without adding height to the fuel cell system other than the spring thickness. The design also has the advantage that it provides a more uniform planar pressure distribution over the various layers of the MEA.

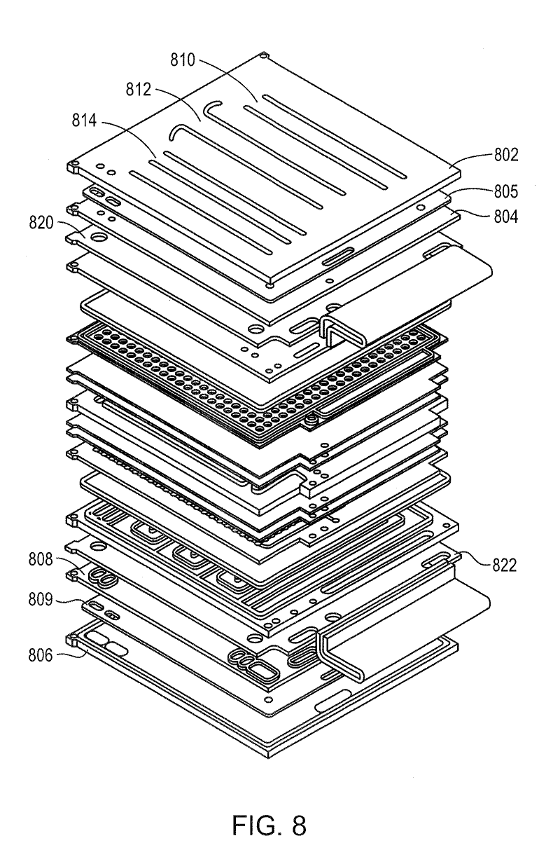

In accordance with another aspect of the invention, the spring element nests into the hot side of the enthalpy exchanger. More specifically, FIG. 8 illustrates an exploded view of a monopolar stack configuration of a fuel cell system with which the present invention may be advantageously employed. The fuel cell system 800 has similar components as those described with reference to FIG. 1. The fuel cell system 800 has an enthalpy exchanger associated with each fuel cell, and the first enthalpy exchanger has hot side element 802, a cold side element 804 and an enthalpy exchange membrane 805 between the hot and cold sides. The second enthalpy exchanger has a hot side 806 and cold side 808 with an enthalpy exchange membrane 809 sandwiched between. In accordance with another aspect of the invention, each hot side element, such as the element 802, has a series of recessed ribs 810, 812, 814, that are formed in the outwardly facing side of the hot side element 802. The spring element 200 nests within the ribs as best illustrated in FIG. 6. This further provides for a completed fuel cell system of minimum dimension in the Z-direction. The ribs also assist in aligning the spring elements during assembly. It should be understood that the hot side element 806 of the second enthalpy exchanger also contains the ribs for receiving the spring element at that side of the fuel cell system, but they are not visible in FIG. 8.

Notably, the heat management and enthalpy exchange assemblies include heat spreader plates, such as plates 820 and 822. The heat spreader plates 820, 822 are substantially formed of copper to collect heat from the fuel cell operation and to direct the heat as needed to other portions of the fuel cell system. In addition, the heat spreader plates also have sufficient bending stiffness to act as a compression plate for each MEA. Typically, adequate MEA compression is at a pressure of about 200 psi. In accordance with this aspect of the invention, this pressure is provided by the two copper heat spreader plates as compressed within the fuel cell system by the spring assembly of the present invention. In this manner, there is no need for a separate compression plate at each end of the fuel cell system. Thus, the spring elements of the present invention in the illustrative embodiment can provide compression for the enthalpy exchange membrane, which is on the order of about 25 psi. Because the heat spreader plate supplies sufficient bending stiffness, a separate compression plate is not required.

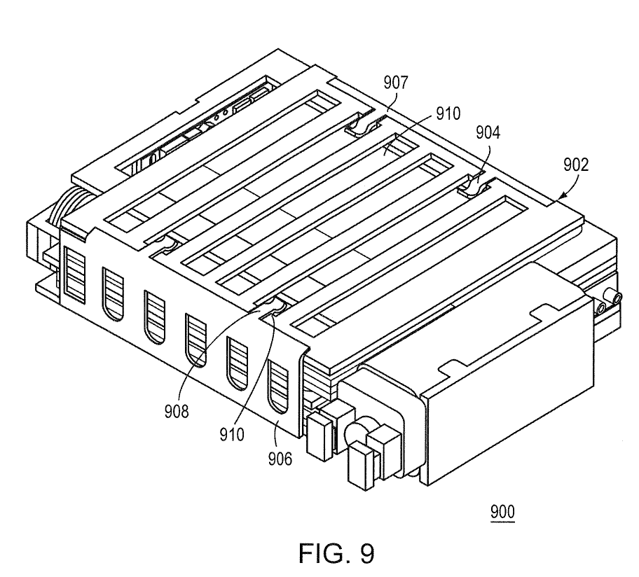

FIG. 9 is an isometric illustration of a complete monopolar stack fuel cell system and spring assembly in accordance with an illustrative embodiment of the present invention. The fuel cell system 900 has the component layers that were described herein, which are securely fastened by spring assembly 902 that includes a first spring element 904 and a second spring element (not visible in FIG. 9), that are locked together by a first side clamp 906 and a second side clamp 907. The side clamp 906 has fastening members, such as the fastening member 908 that each have a curved portion 910, that fits tightly into a recess in the respective groove of the spring element to provide a self-locking mechanism between the side clamp and the spring elements, without bolts, pins or other additional devices. The hot side of the first enthalpy exchanger 910 includes ribs into which the spring element 904 nests. The same arrangement is in place on the opposite side of the fuel cell system. As noted, the heat spreader plates distribute the compression force over the MEAs of each fuel cell.

The invention can also be readily employed with a single fuel cell system which has a single heat spreader plate acting as the compression plate. In such an embodiment, the spring assembly of the present invention still has a top spring and a bottom spring, such as that shown in the Figures.

It should be understood that the present invention has many advantages including that it provides a monopolar stack fuel cell system that is creep tolerant and compact. It also uses a minimum of material for each components of the spring assembly due to the geometry of each part. In addition, in a fuel cell system that includes an internal heat spreader plate with sufficient bending stiffness that also acts as a compression plate and stabilizer, there is no need for a separate compression plate resulting in a more compact stack assembly. It should be understood that the design provides for the minimum in addition height to the fuel cell system and with an interlocking mechanism between the side clamps and the spring elements, additional bolts pins and plastic moldings are avoided. The present invention provides a fuel cell system that is compact with a reduced number of components thus minimizing complexity, costs, as well as size and weight in a system that is optimally small, lightweight and cost effective in order to satisfy commercial applications.

What is claimed is:

1. A spring assembly for use with a direct oxidation fuel cell system, comprising:
a pair of spring elements, each spring element being a flat spring having a curved cross section when undeformed and being substantially flat when deformed, each said spring element being comprised of a single sheet of metal having a plurality of spaced parallel beams, each spring element also having one or more grooves formed therein adapted to receive a fastening member of a side clamp, said spring elements being a top and bottom spring element, respectively; and
a pair of side clamps, each side clamp having a body portion adapted to be received over two opposite sides of the direct oxidation fuel cell system, each said side clamp having at least one fastening member extending generally perpendicular to a body portion of said side clamp, and said fastening member having a curved portion that engages a groove in said spring element whereby the fastening members of said side clamps form a self-locking mechanism to compress said top and bottom spring elements in a substantially flat shape over a top and bottom of the direct oxidation fuel cell system, respectively.

2. The spring assembly as defined in claim 1 where said beams are shaped in such a manner that they are of greater width in a center portion and are narrower at an end near a perimeter of said spring element such that the spring element as a whole is subjected to a substantially constant stress when deformed.

3. The spring assembly as defined in claim 1 wherein said fastening members of said side clamp are received into the grooves of said spring elements such that the overall dimension in a Z-direction of said fuel cell system is maintained and is not substantially increased.

4. The spring assembly as defined in claim 1 wherein said spring elements are substantially comprised of at least one of high strength stainless steel, carbon steel, titanium, or other metal alloys.

5. The spring assembly as defined in claim 1 wherein said single sheet of metal is generally rectangular and sized to encompass an outer surface of the direct oxidation fuel cell system.

6. A direct oxidation fuel cell system, comprising:
A) a monopolar stack configuration fuel cell including:
(i) pair of membrane electrode assemblies, each having an anode aspect and a cathode aspect;
(ii) an anode current collector;
(iii) an enthalpy exchange assembly having:
a hot side element, said hot side element having a plurality of ribs formed an outer surface thereof facing the ambient environment;
a cold side element, said cold side element acting as a current collector and also including a heat spreader plate for collecting and directing heat to other parts of the fuel cell system; and
an enthalpy exchange membrane sandwiched between said hot side element and said cold side element; and
B) a spring assembly comprising
(i) a pair of spring elements, each spring element being a flat spring having a curved cross section when undeformed and being substantially flat when deformed, each said spring element being comprised of a single sheet of metal having a plurality of spaced parallel beams, said beams being sized to be received in a nesting configuration within the ribs of said outer surface of said hot side elements of said fuel cell assembly, each spring element also having one or more grooves formed therein adapted to receive a fastening member of a side clamp, said spring elements being a top and bottom spring element, respectively; and
(ii) a pair of side clamps, each side clamp having a body portion adapted to be received over two opposite sides of the direct oxidation fuel cell system, each said side clamp having at least one fastening member extending generally perpendicular to a body portion of said side clamp, and said fastening member having a curved portion that engages a groove in said spring element whereby the fastening members of said side clamps form a self-locking mechanism to compress said top and bottom spring elements in a substantially flat shape over the hot side of the enthalpy exchanger at each of a top and bottom portion of the direct oxidation fuel cell system, respectively.

7. The direct oxidation fuel cell system as defined in claim 6 wherein said heat spreader plate has sufficient bending stiffness such that the plate acts as a compression plate to substantially provide adequate membrane electrode assembly compression.

8. The direct oxidation fuel cell system as defined in claim 7 wherein said spring elements have a free height that is substantially higher than the membrane electrode assembly compression such that the spring elements counteract membrane electrode assembly creep without significant compression reduction of the stack such that the direct oxidation fuel cell system is substantially creep tolerant.

9. The direct oxidation fuel cell system as defined in claim 6 wherein said fastening members of said side clamp are received into the grooves of said spring elements such that the overall dimension in a Z-direction of said fuel cell system is maintained and is not substantially increased.

10. The direct oxidation fuel cell system as defined in claim 9 wherein said spring elements when deformed and compressed by said side clamps provide substantially adequate compression for said enthalpy exchange membrane.

11. The direct oxidation fuel cell system as defined in claim 6 wherein said beams of said spring elements are shaped in such a manner that they are of greater width in a center portion and are narrower at an end near a perimeter of said spring element such that the spring element as a whole provides a substantially constant stress when deformed.

12. The direct oxidation fuel cell system as defined in claim 6 wherein said spring elements are substantially comprised of at least one of high strength stainless steel, carbon steel, titanium, or other metal alloys.

13. The direct oxidation fuel cell system as defined in claim 6 wherein each said spring elements is generally rectangular and sized to encompass an outer surface of the direct oxidation fuel cell system.

14. A method of securing a direct oxidation fuel cell system, comprising:
forming a pair of spring elements of a single sheet of metal that is generally rectangular and is curved when uncompressed, said curve providing a free height that allows the spring element when deformed to provide a desired amount of compression for the direct oxidation fuel cell; and
providing side clamps that engage said spring elements by a self locking mechanism such that said spring elements are securely fastened and compressed over a direct oxidation fuel cell system without additional bolts, pins or other fasteners.

15. The method of securing a direct oxidation fuel cell system as defined in claim 14, further comprising:
providing at least one heat spreader plate that also acts as a compression plate to distribute uniformly adequate membrane electrode assembly compression for operation of at least one direct oxidation fuel cell in said fuel cell system.

16. The method of securing a direct oxidation fuel cell system as defined in claim 15, further comprising:
selecting a free height for said spring elements such that the elements when deformed provide adequate compression for an enthalpy exchange assembly in at least one fuel cell in the fuel cell system.

17. The method of securing a direct oxidation fuel cell system as defined in claim 14, further comprising:
selecting a material for said spring elements such that the spring elements slightly deform when an associated membrane electrode assembly exhibits creep.

18. A direct oxidation fuel cell system, comprising:
A) a direct oxidation fuel cell including:
(i) a membrane electrode assembly, having an anode aspect and a cathode aspect;
(ii) an anode current collector;
B) an enthalpy exchange assembly disposed adjacent to said direct oxidation fuel cell, said enthalpy exchange assembly having:
a hot side element, said hot side element having a plurality of ribs formed an outer surface thereof facing the ambient environment;
a cold side element, said cold side element acting as a current collector and also including a heat spreader plate for collecting and directing heat to other parts of the fuel cell system; and
an enthalpy exchange membrane sandwiched between said hot side element and said cold side element; and
C) a spring assembly comprising:
(i) a pair of spring elements, each spring element being a flat spring having a curved cross section when undeformed and being substantially flat when deformed, each said spring member being comprised of a single sheet of metal having a plurality of spaced parallel beams, said beams of at least one of said spring elements being sized to be received in a nesting configuration within the ribs of an outer surface of said hot side element of said enthalpy exchange assembly, each spring element also having one or more grooves formed therein adapted to receive a fastening member of a side clamp, said spring elements being a top and bottom spring element, respectively; and
(ii) a pair of side clamps, each side clamp having a body portion adapted to be received over two opposite sides of the direct oxidation fuel cell, each said side clamp having at least one fastening member extending generally perpendicular to a body portion of said side clamp, and said fastening member having a curved portion that engages a groove in said spring element whereby the fastening members of said side clamps form a self-locking mechanism to compress said top and bottom spring elements in a substantially flat shape over a top and bottom portion of the direct oxidation fuel cell system, respectively.

19. The direct oxidation fuel cell system as defined in claim 18 wherein said heat spreader plate has sufficient bending stiffness that is also acts as a membrane electrode assembly compression plate in the fuel cell system.

20. The direct oxidation fuel cell system as defined in claim 19 wherein at least one spring element has a free height that is substantially higher than the membrane electrode assembly compression, such that it counteracts membrane electrode assembly creep without significant compression reduction of the fuel cell system.
